(19) United States
(12) Patent Application Publication
(10) Pub. No.: US 2009/0107299 A1
(43) Pub. Date: Apr. 30, 2009

(54) RATCHETING SERPENTINE BELT TOOL

(75) Inventor: Randall J. Ploeger, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/928,374

(22) Filed: Oct. 30, 2007

(51) Int. Cl. B25B 13/46

(52) U.S. Cl. 81/62

(57) ABSTRACT

A serpentine belt tool for releasing tension on a serpentine belt biased by an idler pulley includes an elongate handle which is connected to a ratchet mechanism. The pawl associated with the ratchet mechanism has three positions including a neutral position which facilitates placement of the tool on an idler pulley.

### BACKGROUND OF THE INVENTION

In a principal aspect the present invention relates to a tool for use to control or adjust the tension of a serpentine belt, particularly a serpentine belt associated with an internal combustion vehicle engine.

Modern diesel and internal combustion engines typically include closed loop flexible belts which have a serpentine shape inasmuch as they fit around and connect a plurality of pulleys associated with various operating components of the engine. Often a serpentine belt is tensioned by means of an idler pulley mounted at the end of a cantilever, spring loaded or spring biased arm. In seeking to repair or replace a component of an engine having a serpentine belt, it may be necessary to release the tension of the idler pulley on the belt.

Various tools have been developed to effect release of the tension of the idler pulley including tools manufactured by applicant's assignee, Lisle Corporation and identified as Serpentine Belt Tools, Product Nos. 57800, 57900 and 57100. Such prior art serpentine belt tools comprise an elongate, flat bar stock handle having one or a pair of configured openings at one end designed to engage the center axle of an idler pulley. The elongate handle may then be manipulated to pivot the idler pulley and the attached spring biased cantilever arm to release the tension on a serpentine belt thereby permitting removal of the belt. Such tools may also include a handle extension which is bolted to the elongate handle to provide further access to an idler pulley located in a hard to reach area of an engine compartment.

Applicant's assignee also has introduced various additional versions of serpentine belt tools such as the version represented by Ser. No. 10/903,782 filed Jul. 30, 2004 which is incorporated herewith by reference and which is submitted on a form PTO/SB/08a.

Despite such advances in the design of serpentine belt tools, problems remained with respect to their utilization. For example, utilizing the tool in an efficient manner in restricted spaces is often difficult. Such movement may be restricted because of the configuration of the engine compartment for example. Thus, there has developed a need to provide an improved design for such a tool.

### SUMMARY OF THE INVENTION

Briefly, the present invention comprises a serpentine belt tool for releasing tension placed upon a serpentine belt by an idler pulley. The tool includes an elongate actuator handle with a manual gripping end and an opposite drive end. A pair of extension plates are fitted over the flat sides of the generally plate shaped handle. The extension plates are utilized to hold a ratchet wheel which cooperates with a pivotal, reversible pawl that is biased to maintain a desired position by a detent element. The pawl may be manually actuated to assume any one of three positions including a neutral or intermediate position between clockwise and counterclockwise driving positions. The extension plates sandwich the component parts comprising the ratchet mechanism. The tool may be utilized in combination with various sizes of sockets inserted in the ratchet wheel to engage the fastener or bolt which mounts the idler pulley on a cantilever arm to thereby maintain a serpentine belt in tension. An optional multi-position, extension arm may be used in combination with the elongate handle and sockets.

One of the benefits of the construction or tool of the invention is the ability to place the reversible pawl in a neutral, non-engaged position. As a consequence, the ratchet wheel and socket may be appropriately positioned and oriented with respect to the elongate handle within the engine compartment of a vehicle. Then, the reversible pawl may be positioned in a clockwise or counterclockwise driving position. This enables efficient positioning or orientation of the handle in the engine compartment and thus facilitates the ability to use the tool in an effective manner.

Thus, it is an object of the invention to provide an improved serpentine belt tension release tool capable of using multiple size sockets, an adjustable lever arm extension, reversible and neutral position operation.

Another object of the invention is to provide a simple, yet rugged, economical, easy to use and efficient tool which may be utilized to release pulley tension on a serpentine belt of a vehicle engine.

Another object of the invention is to provide a serpentine belt tool which provides for a ratchet wheel adjustment and includes associated therewith enablement of clockwise, counterclockwise and neutral positioning of the ratchet wheel relative to a drive handle.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a plan view of a partially assembled tool of an embodiment of the invention;

FIG. 2 is a side elevation of the tool of FIG. 1;

FIG. 3 is a plan view of the assembled tool of FIG. 1 including a grip attached thereto;

FIG. 4 is a plan view of an extension that may be utilized in combination with the tool of FIG. 3;

FIG. 5 is a side view of the extension of FIG. 4;

FIG. 6 is a view of various drive assemblies that may be utilized in combination with the handle and/or extension of FIGS. 3 and 4;

FIG. 7 is an exploded isometric view of the tool of FIGS. 3 and 4; and

FIG. 8 is an isometric view depicting the manner of use of the tool embodiment of FIGS. 1-7.

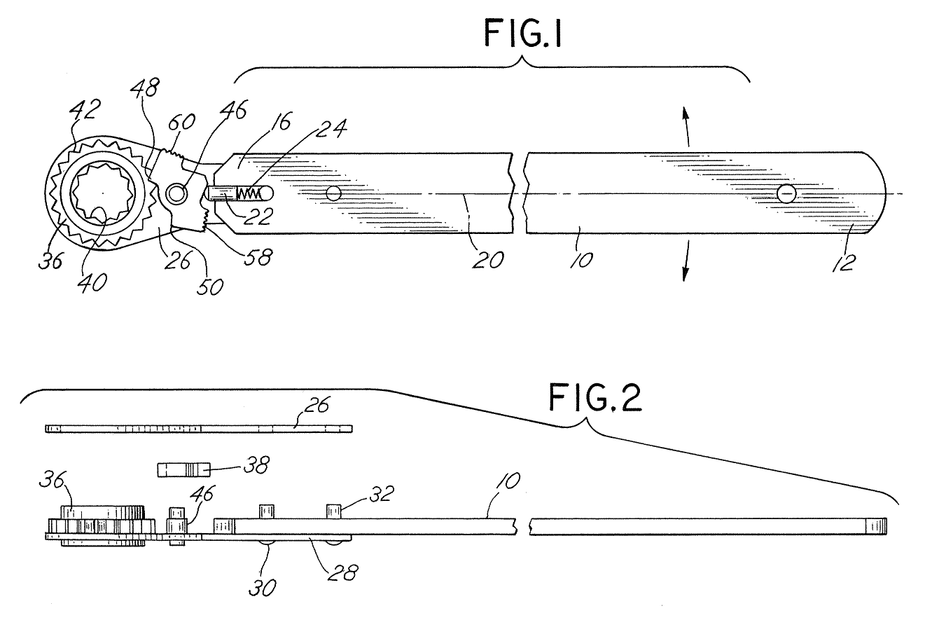

### DESCRIPTION OF AN EMBODIMENT OF THE INVENTION

The tool of the invention, in the embodiment depicted, includes an elongate actuation handle 10 having a manual grip end 12 with a foam grip material 14 molded or fastened thereto. Typically, the handle 10 is in the range of 10 to 20 inches in length. The handle 10 is in the form of a flat plate with a drive end 16 opposite the manual grip end 12. The drive end 16 includes an elongate slot 18 which extends longitudinally along a center line axis 20 of the handle 10. The elongate slot 18 includes a plunger pin 22 biased outwardly by a spring 24 along the longitudinal axis 20.

A first end cover plate 26 and a second end cover plate 28 are positioned on opposite sides of the handle 10 at the drive end 16 and are retained by solid rivets 30 and 32. The end plates 26 and 28 are thus held in position and constitute longitudinal extensions of the elongate actuator handle 10. The end plates 26, 28 retain a rotatably mounted ratchet wheel 36 and a reversible pawl 38 therebetween. The ratchet wheel 36 includes a configured internal passage 40 for cooperation with a fastener head or sockets and external teeth 42 which cooperate with the reversible pawl 38. The reversible pawl 38 is mounted on a pivot pin 46 connected between plates 26, 28 and is pivotal about the axis of the pivot pin 46. The reversible pawl 38 includes a first tooth 48 which engages the teeth 42 of the ratchet wheel 36 or alternatively a second tooth 50 to engage teeth 42 so as to enable clockwise or counterclockwise movement of the wheel 36 in response to the rotation of the manual handle 10 in either a clockwise or a counterclockwise direction.

Importantly, the reversible pawl 38 includes a neutral detent position 56 wherein the pawl 38 does not engage the ratchet wheel 36. Thus, the handle 10 may be rotated relative to the wheel 36 which is sandwiched between the end plates 26 and 28. The pawl 38 may then be engaged with the ratchet wheel 36 to effect clockwise or counterclockwise movement thereof.

Movement of the pawl 38 is effected by manually engaging the projecting tabs 58 or 60 of the reversible pawl 38 and pivoting the pawl 38 manually. It is to be noted that the component parts of the tool are in the form of flat bar stock in order that the tool may be fitted conveniently into an engine compartment.

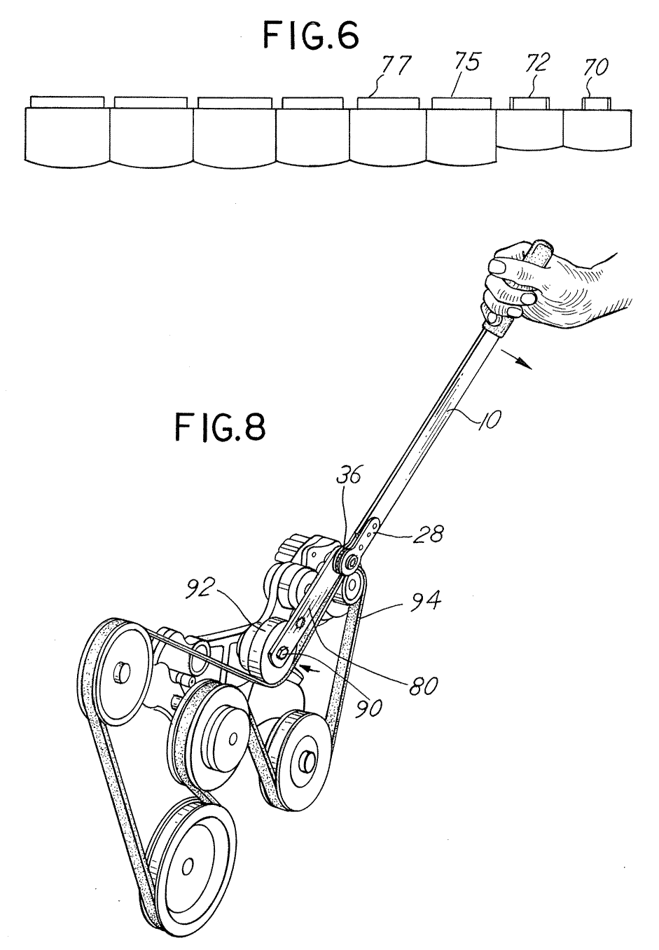

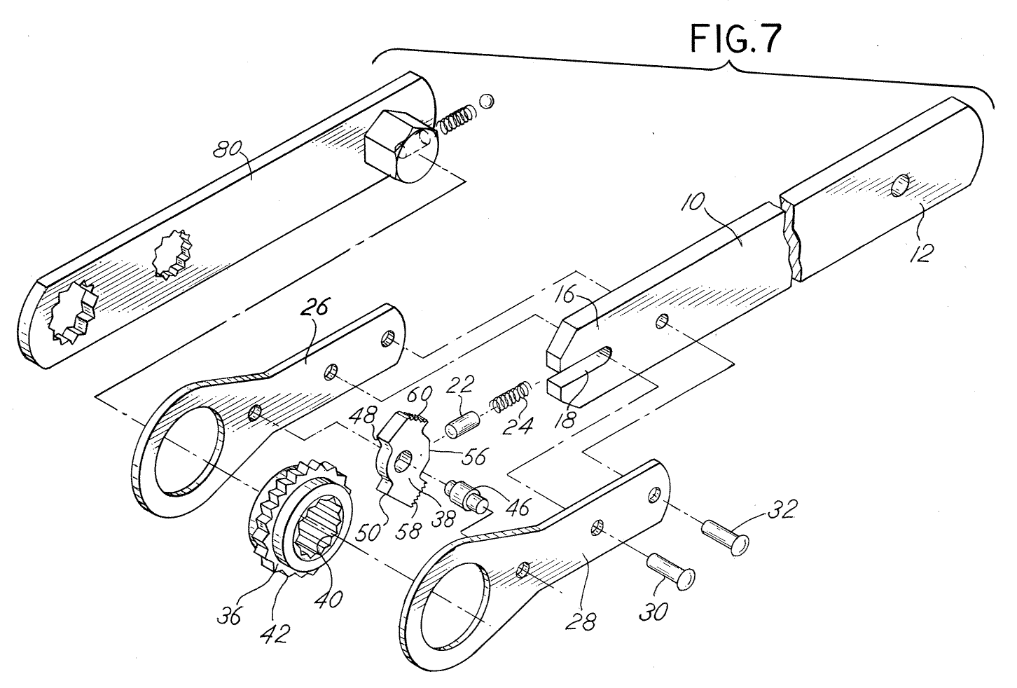

In use, the faceted passage or opening 40 associated with the ratchet wheel 36 is engaged with an appropriate driver or socket such as shown in FIG. 6. For example, a series of differently sized, separate drivers or sockets 70, 72, 75, 77, etc. are provided, each one of which may be fitted into the opening 40 of ratchet wheel 36 and are chosen to engage with a fastener 90 holding an idler pulley 92 in position in association with the serpentine belt 94 as depicted in FIG. 8.

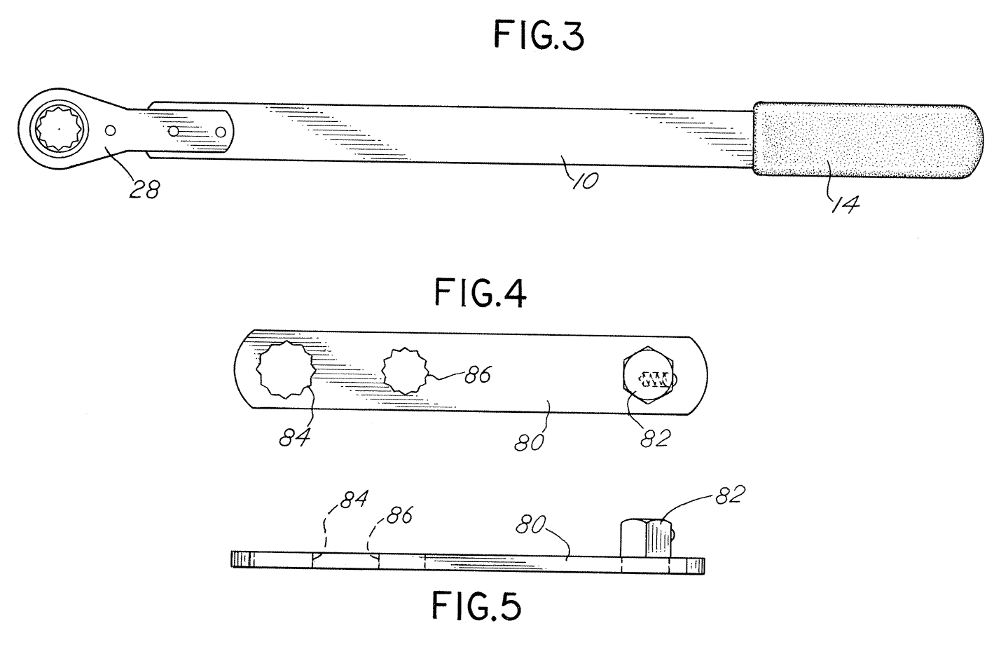

Additionally, it is possible to utilize the tool by incorporating an extension assembly. Thus, an extension bar 80 includes a driver 82 which may be fitted through the ratchet wheel 36 opening 40. The opposite end of the extension bar 75 may include a faceted opening 84 or an additional opening 86, either of which may be engaged with the fastener or socket associated with an idler pulley again as shown, for example, in FIG. 8. Thus, the tool, such as depicted in FIG. 3, may be combined with the extension of FIG. 5 and the various drivers or sockets such as shown in FIG. 6 to provide a tool that will release the tension on a serpentine belt pulley assembly regardless of the size of the fastener which holds the pulley in position. The tool thus has a wide range of applicability and utility.

An important feature of the invention is associated with the fact that there is a neutral position associated with the ratchet mechanism. The ratchet mechanism neutral position enables the automotive technician to place the tool in a free float or neutral position. The tool, in the neutral position, may then be placed onto the fastener that retains the serpentine belt pulley. The technician can then orient the handle 10 and engage the pulley fastener head more quickly, disengage the neutral position and move the position of the handle of the tool to ratchet the pulley out of a tension position. This characteristic or feature of the invention is also a benefit when utilizing the extension inasmuch as it provides for greater flexibility with respect to the positioning and use of the extension.

While an embodiment of the invention has been disclosed, the invention is limited only by the following claims and equivalents thereof.

1. A serpentine belt tool for releasing tension upon a serpentine belt tensioned by a biased idler pulley comprising:
a first elongate actuation handle having a manual grip end, and a drive end, a longitudinal, center line axis, an elongate slot at the drive end aligned with the axis;
a biased pin extending axially and biased from the slot;
an extension plate attached to the drive end and including a ratchet wheel with a ratchet drive passage, said ratchet wheel including a configured internal passage and external ratchet teeth;
a reversible pawl having a pivot axis pivotally mounted on the extension plate, said pawl including first and second ratchet wheel engaging teeth on opposite sides of the pivot axis, and a three position cam surface on the pawl including a neutral position, a clockwise ratchet wheel pawl drive position and a counterclockwise ratchet wheel drive position, said neutral position intermediate the clockwise and counterclockwise pawl positions and comprising a generally flat face for engagement by the pin extending from the slot to thereby define a detent position to maintain said pawl in said neutral position, said pawl further including a recessed detent pocket on each side of the flat face; and
a biased pawl engaging detent element comprising said pin for maintaining the pawl in one of the three positions, said pawl including first and second tabs on opposite sides of the pivot axis for manual engagement to position the pawl in one of the three positions;
said handle comprising a single, generally flat sided plate and the extension plate comprising first and second substantially identical flat end plates lying against and extending respectively from opposite flat planar sides of the handle with the ratchet wheel, pawl and detent element between said end plates and said pin slidably retained in said actuation handle slot by the extension plates overlying said slot.

2. (canceled)

3. The tool of claim 1 further including an extension bar including a drive at one end and a ratchet passage at the opposite end for engaging a fastener.

4. The tool of claim 3 wherein the extension includes first and second ratchet passages.

5. (canceled)
